(19) United States
(12) Patent Application Publication
(10) Pub. No.: US 2004/0093784 A1
(43) Pub. Date: May 20, 2004

(54) Fishhook baiting apparatus

(76) Inventors: Todd A. Brahm, Payson, AZ (US); Rhonda G. Brahm, Payson, AZ (US)

Correspondence Address: Ryan & Engnath, Suite 104, 8469 N. Millbrook, Fresno, CA, 93720, US

(21) Appl. No.: 10/654,839

(22) Filed: Sep. 3, 2003

Related U.S. Application Data
(60) Provisional application No. 60/427,334, filed on Nov. 19, 2002.

(51) Int. Cl. A01K 1/00

(52) U.S. Cl. 43/4

(57) ABSTRACT

An apparatus for baiting a fishhook that eliminates the need for the user to touch or otherwise directly handle the bait, thereby avoid transferring the bait or its smell to the user and his or hers clothes. The fishhook baiting apparatus has plunger member slidably disposed in a bait chamber formed by a generally elongated tubular member. One end of the tubular member is configured to be inserted into a supply of bait such that a portion of the bait is placed inside the bait chamber. The fishhook is placed inside the bait in the bait chamber and the bait is then compressed around the fishhook by pushing the open end of the tubular member against a hard surface. The plunger member is utilized to eject the bait and fishhook from the bait chamber. The result is a fishhook that is substantially encased by the bait.

### CROSS-REFERENCE TO RELATED APPLICATIONS

This application claims the benefit of U.S. Provisional Application No. 60/427,334 filed Nov. 19, 2002 and Document Disclosure No. 505,865 dated Feb. 13, 2002.

### BACKGROUND OF THE INVENTION

A. Field of the Invention

The field of the present invention relates generally to apparatuses used to place a quantity of fish bait onto a fishhook. More specifically, the present invention relates to such apparatuses that are configured to allow a person to place bait on a fishhook without having to handle or come in direct contact with the bait. Even more specifically, the present invention relates to such apparatuses that are configured to substantially encase a quantity of bait about a variety of different types of fishhooks.

B. Background

Many people enjoy fishing, whether it is for commercial, sport or leisure purposes. Various types of baits are used to attract the fish to the hook, including various commercially available soft, paste or dough-types of bait, typically supplied in jars or other containers, and hard or soft cheese. Because it is generally well known that fish are attracted to strong smells and the visual appearance of food, the bait is typically made out of materials having a strong odor (i.e., some of the bait is referred to as “stink bait”) and which are colored (i.e., bright orange material) to attract the fish to the hook. Ideally, for most fishing activities, it is desirable that the bait substantially cover the metal hook and overpower any human or metallic smell that may be associated with the hook to reduce the risk of scaring away an approaching fish.

One aspect of fishing that is not necessarily enjoyed by the typical fisherman or woman is the process of placing the bait on the hook. The usual process of baiting a hook consists of using the fingers to remove a quantity of bait from a larger quantity of the bait, such as a container of the bait, and placing the bait on the hook in a manner that prevents it from falling off during casting or being easily removed by a nibbling fish (i.e., without hooking the fish). This generally requires the person to utilize his or her hands to compress and encase the bait around the hook and squeeze, roll or otherwise compress the bait on the hook, particularly if multiple casting is desired. Unfortunately, this can result in the hook being accidently stuck in the person's hand and will result in the bait being on the person's hands. Once on the hands, the bait will end up everywhere the person touches while having bait thereon, such as skin, clothing, hat, tools and other fishing materials. As such, the beneficial odor and color aspects of the bait, for fishing purposes, becomes a problem for the fisherman or woman.

A number of apparatuses for baiting a fishhook are known in the prior art. For example, U.S. Pat. No. 5,117,571 to Sites describes a fishhook baiting device that is configured for applying bait to a hook without touching the bait. This device has a dispenser head assembly having a hook chamber, a bait chamber in communication with the hook chamber and a plunger assembly to push the bait from the bait chamber into the hook chamber. The hook in the hook chamber is covered by the bait. The combination hook and bait are pushed out of the device by the plunger. U.S. Pat. No. 4,850,129 to Hoepfner, et al. also describes a bait forming gun configured to bait a hook without having to touch the bait. The gun has a slotted barrel in which is placed a standard fishhook and a plunger for pushing the baited hook from the gun. In use, the hook is placed in the slotted barrel, and the hook and barrel are driven into the bait to remove a quantity of bait and encase it around the hook. The plunger ejects the encased hood from the barrel. U.S. Pat. No. 4,428,146 to Walker describes a fish bait dispenser for use with salmon eggs or the like that dispenses one bait component at a time into a slotted area so as to allow the fisherman to place the hook through the bait without touching the bait. U.S. Pat. No. 3,964,204 to McKinley describes a fish bait dispenser having a cylinder for receiving the bait and a rotatable mechanism for moving a quantity of the bait into position where the fisherman can place the hook through the bait without directly touching the bait. The patents described above are representative of known apparatuses for use in placing bait on a hook without touching the bait.

Although the prior art discloses a number of apparatuses for baiting a fishhook with bait, there are certain characteristics of the known apparatuses that limit their complete acceptance, usefulness and/or cost effectiveness. For instance, it is well known that the apparatuses that have a number of moving components can become jammed with bait or suffer from the water, dirt or other materials found in the typical fishing environment. In addition, these apparatuses tend to be more complicated to operate and more expensive to make and buy. Some of the aforementioned apparatuses do not fully encase the bait around the hook and/or are limited to standard, single prong fishhooks. What is needed, therefore, is a fishhook baiting apparatus that is capable of substantially encasing the bait around a variety of different types of hooks without requiring the fisherman or woman to touch or directly contact the bait. The desired fishhook baiting apparatus should substantially resist becoming jammed or otherwise non-functional when used with bait and in the typical fishing conditions. In addition, the fishhook baiting apparatus should be relatively inexpensive to manufacture and simple to use.

### SUMMARY OF THE INVENTION

The fishhook baiting apparatus of the present invention solves the problems and provides the benefits identified above. That is to say, the present invention discloses a fishhook apparatus particularly configured to allow the fisherman or woman to substantially encase fish bait around a variety of different types of hooks, including treble hooks and the like, without having to touch the bait or handle the barbed end of the hook. The fishhook baiting apparatus of the present invention is very simple to make and easy to use. The configuration of the fishhook baiting apparatus results in it being relatively free from jamming or other problems associated with the bait and/or typical fishing conditions.

In one aspect of the present invention, the fishhook baiting apparatus has a generally elongated tubular member with a first end, a second end and a bait chamber disposed the first and second ends. The first end of the tubular member is configured to be inserted or driven into a supply of bait and receive a quantity of the bait in the bait chamber. In one configuration, the tubular member is made out of a transparent material. An elongated plunger member is slidably disposed in the bait chamber. The plunger member has a first end configured to engage the bait in the bait chamber and a second end configured to prevent complete entry of the plunger member into the bait chamber. A plunger body is configured to slidably engage the interior of the bait chamber. Preferably, the second end of the tubular member and the first end of the plunger member are cooperatively configured to prevent the first end of the plunger member from being easily removed from the second end of the tubular member. Likewise, the first end of the tubular member and the first end of the plunger member can be cooperatively configured to prevent the first end of the plunger member from being extending substantially beyond the end of the tubular member. A disk member located at the second end of the plunger member is sized and configured to prevent complete entry of the plunger member into the bait chamber. The first end of the tubular member is sized and configured to substantially completely receive the fishhook, whether the standard single prong type or the treble prong type, inside the bait chamber. Lateral extensions on the second end of the tubular member are configured to permit grasping of the tubular member. In one configuration, the lateral extensions are generally perpendicular to the longitudinal axis of the tubular member.

Accordingly, the primary objective of the present invention is to provide an improved fishhook baiting apparatus that provides the advantages discussed above and that overcomes the disadvantages and limitations associated with presently available apparatuses for baiting a fishhook.

It is also an important objective of the present invention to provide a fishhook baiting apparatus that allows the fisherman or woman to substantially encase bait about a fishhook without having to touch or directly handle the bait.

It is also an important objective of the present invention to provide a fishhook baiting apparatus that is adaptable for use with different sizes and configurations of fishhooks.

It is also an important objective of the present invention to provide a fishhook baiting apparatus that comprises an elongated tubular member having a first end adapted to be inserted into fish bait and receive a quantity of that bait inside the tubular member and a plunger member slidably received in the tubular member and configured to eject the bait and encase a fishhook with the bait.

It is also an important objective of the present invention to provide a fishhook baiting apparatus that is relatively easy to manufacture, use and carry and which is less susceptible to jamming, clogging or other problems.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a side view of the fishhook baiting apparatus of the present invention showing the plunger member engaged in a transparent tubular member;

FIG. 2 is an exploded side view of the fishhook baiting apparatus of the present invention shown in FIG. 1;

FIG. 3 is a side view of the fishhook baiting apparatus of the present invention placed against a source of bait prior to receiving a quantity of bait into the tubular member;

FIG. 4 is a side view of the fishhook baiting apparatus of the present invention having received a quantity of bait into the tubular member;

FIG. 5 is a perspective view of the fishhook baiting apparatus of the present invention prior to inserting the fishhook into the bait inside the tubular member;

FIG. 6 is a perspective view of the fishhook baiting apparatus of the present invention showing the fishhook inserted into the quantity of bait inside the tubular member;

FIG. 7 is a side view of the fishhook baiting apparatus of the present invention showing the quantity of bait being substantially encased around the fishhook; and

FIG. 8 is a perspective view of the fishhook baiting apparatus of the present invention showing the fishhook and encased quantity of bait removed from the tubular member.

### DETAILED DESCRIPTION OF THE PREFERRED EMBODIMENTS

With reference to the figures where like elements have been given like numerical designations to facilitate the reader's understanding of the present invention, and particularly with reference to the embodiment of the fishhook baiting apparatus of the present invention illustrated in the figures, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

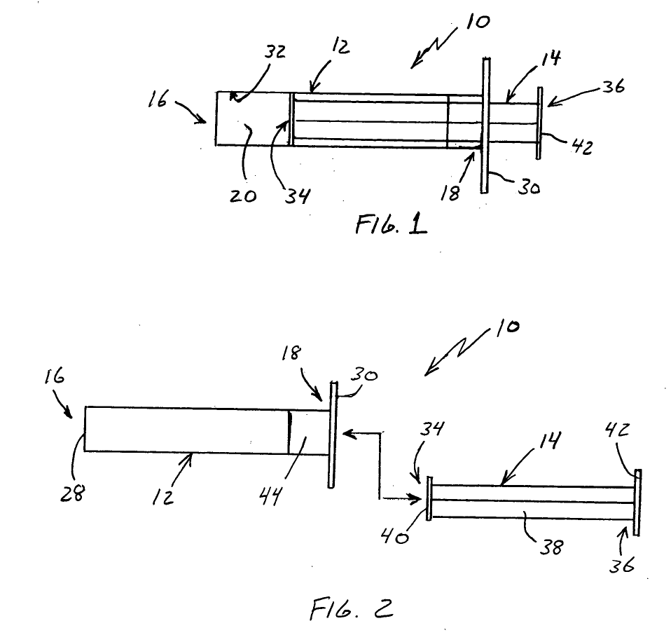

A preferred embodiment of the fishhook baiting apparatus of the present invention, identified generally as 10 in the figures, primarily comprises a generally elongated tubular member 12 in which is slidably disposed a plunger member 14, as best shown in FIG. 1. Tubular member 12 has a first end 16 and an opposing second end 18 forming a bait chamber 20 disposed therebetween. As shown in FIGS. 3 through 8 and explained in more detail below, bait chamber 20 is configured for receiving and discharging a quantity of bait 22 from source of bait 24 so as to substantially encase fishhook 26 without requiring the fisherman or woman to contact the quantity of bait 22 or the bait inside the source of bait 24. Source of bait 24 for fishhook baiting apparatus 10 of the present invention can be soft or hard baits, including the dough-type of bait (i.e., Power Bait®), hard and soft cheese and cheese-like baits and stink bait. As is known in the art, these types of baits are often provided in jars or other containers or as solid sections of the material used for bait, such as the cheese exemplified as the source of bait 24 in FIGS. 3 and 4. Source of bait 24 may be provided in other forms as well.

As explained below, in the preferred embodiment of the fishhook baiting apparatus 10 of the present invention the relationship between tubular member 12 and plunger member 14 is in the general form of a hypodermic syringe (but without the tight suction fit between tubular member 12 and plunger member 14). In one configuration of fishhook baiting apparatus 10, both tubular member 12 and plunger member 14 are made out of a plastic material that is suitable for use in the typical fishing environment. Although other materials may be utilized for fishhook baiting apparatus 10 of the present invention, including various metals, composites and combinations of materials, plastic is preferred due to its corrosion resistance capabilities, ease of manufacturing, lightweight and adaptability for different sizes of fishhook baiting apparatuses 10. As set forth below, the materials chosen for the various components of fishhook baiting apparatus 10 need to be sufficiently stiff so that force may be applied thereto as necessary to accomplish the baiting objectives.

In a preferred embodiment, first end 16 of tubular member 12 has a sharpened edge 28 to better cut the desired quantity of bait 22 from source of bait 24. Sharpened edge 28 can be provided by tapering first end 16 such that the narrowest portion extends away from bait chamber 20 or by providing tubular member 12 with a relatively thin wall to form bait chamber 20. Although a sharpened edge 28 has substantial benefits when used with hard baits, the open tubular end of first end 16 without any “sharpening” is generally sufficient for most dough-type baits, soft cheeses and the like. The preferred tubular member 12 has one or more lateral extension 30 at second end 18 to make it easier for the fisherman or woman to grasp tubular member 12 when using fishhook baiting apparatus 10 to obtain the quantity of bait 22 from source of bait 24. As explained below, lateral extension 30 should be stiff enough to allow the user to apply force thereto and cause tubular member to cut into the source of bait 24 (FIG. 4) and encase the quantity of bait 22 around fishhook 26 (FIG. 7). In one configuration, lateral extension 30 comprises a pair of wing members 30a and 30b extending outwardly from opposite sides of tubular member 12 in a manner that is generally perpendicular to the longitudinal axis of tubular member 12. As explained below, lateral extension 30 should extend outwardly from tubular member 12 a sufficient distance that the user can easily place his or her fingers under lateral extension 30 on the outside of tubular member 12 to permit the user to hold tubular member generally still while ejecting the source of bait 22 from inside bait chamber 20 (much the way that one would hold a hypodermic syringe when in use). The preferred embodiment of the present invention also utilizes a transparent tubular member 12 so that the user can see how much bait 22 is drawn inside bait chamber 20. Preferably, the inside wall 32 of tubular member 12 is generally smooth to facilitate movement of the quantity of bait 22 in and out of tubular member 12 and the sliding action of plunger member 14 inside bait chamber 20.

As stated above, plunger member 14 is configured to be slidably engaged inside bait chamber 20 of tubular member 12. Plunger member 14 has a first end 34 and an opposing second end 36 with a plunger body 38 disposed therebetween. If desired, plunger body 38 may be configured in the shape of a cylindrical tube that has an outside diameter suitable for easily sliding along inside wall 32 of bait chamber 20. Alternatively, plunger body 38 may be of any shape or configuration that allows plunger member 14 to move relatively freely inside bait chamber 20 while preventing jamming due to quantity of bait 22 or other material inside bait chamber 20. First end 34 of plunger member 14 should be configured to engage the quantity of bait 22 inside bait chamber 20 in a manner that permits plunger member 14 to easily eject or discharge the quantity of bait 22 from inside bait chamber 20. In one configuration, first end 34 is configured to be a generally circular member 40 having an outer dimension only slightly smaller than the inside diameter of tubular member 12. In this manner, bait material from the quantity of bait 24 drawn inside bait chamber 20 will not get between first end 34 of plunger member 14 and second end 18 of tubular member 12 where it could cause clogging or other undesirable effects. Second end 36 of plunger member 14 is configured to prevent complete entry of plunger member 14 into bait chamber 20. In the configuration shown in the figures, second end 36 of plunger member 14 has disk member 42 that is sized and configured to be of a greater dimension than bait chamber 20.

Fishhook baiting apparatus 10 can be configured to prevent the unintentional complete removal of plunger member 14 from tubular member 12 and/or the first end 34 of plunger member 14 from exiting much past first end 16 of tubular member 12 during the ejection of the quantity of bait 22 from bait chamber 20. Separation of plunger member 14 from tubular member 12 can result in one of the components being misplaced, thereby making apparatus 10 non-functional. Preventing first end 34 of plunger member 14 from fully exiting past first end 16 of tubular member 12 will help prevent bait, dirt, fish parts and other materials from being lodged between first end 34 of plunger member 14 and second end 18 of tubular member 12, which can cause jamming or clogging of tubular member 14 in bait chamber 20. This concern may be particularly an issue where plunger body 38 is smaller than smaller than circular member 40.

One device suitable for accomplishing the above objective is to utilize a reduced diameter area 44 inside bait chamber 20 at or near second end 18 of tubular member 12 that is configured to prevent first end 34 of plunger member 14 from being withdrawn past second end 18 of tubular member 12. Reduced diameter area 44 can be created from additional material along the inside wall 32 of tubular member 12. Circular member 40 can be sized and configured to easily slide along inside wall 32 of tubular member 12 until it contacts reduced diameter area 44, which can be configured to prevent circular member 40 from going past second end 18 of tubular member. Alternatively, the relationship between circular member 40 and reduced diameter area 44 can be such that, with enough additional force, the user can pull plunger member 14 out of bait chamber 20 for cleaning or other beneficial purposes. To prevent first end 34 of plunger member (i.e., circular member 40) from going much beyond first end 16 of tubular member 12, a reduced diameter area 44 can also be located at or near first end 16 of tubular member 12. Alternatively, plunger body 38 can have one or more protrusions (not shown) at or near second end 36 of plunger member 14 that interact with reduced diameter area 44 at or near second end 18 of tubular member 12 to prevent first end 34 of plunger member 14 from going past first end 16 of tubular member 12. Other devices used with tubular member 12 and plunger member 14 can also provide the benefits described herein.

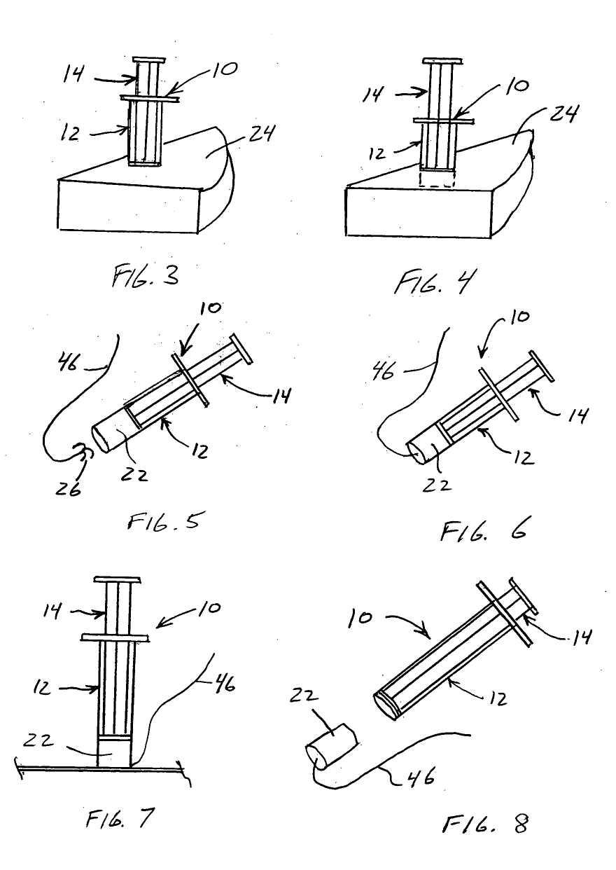

In use with the preferred embodiment of apparatus 10 of the present invention, the user of apparatus 10 loads the bait into apparatus 10 by placing first end 16 of tubular member 12 against the source of bait 24, as shown in FIG. 3, and pushing on lateral extension 30 to insert first end 16 into bait 24 until the desired quantity of bait 22 is inside bait chamber 20, as shown in FIG. 4. During the bait loading process, plunger member 14 is allowed to move freely in response to the entry of the quantity of bait 22 into bait chamber 20. Once the desired quantity of bait 22 is inside bait chamber 20, the user will pull tubular member 12 out of the source of bait 24. Depending on the type of bait, the user can merely pull on lateral extension 30 to remove tubular member 12 from source of bait 24 or it may be beneficial to twist tubular member 12 in source of bait 24 prior to pulling on tubular member 12 to make it easier to pull out. With quantity of bait 22 inside bait chamber 20, as shown in FIG. 5, the user pushes fishhook 26, shown with fishing line 46 attached, into the quantity of bait 22 by grasping the non-hook end of fishhook 26. Once the fishhook is placed inside quantity of bait 22, as shown in FIG. 6, the user then grasps the lateral extension 44 and presses first end 16 of tubular member 12 against a hard surface, such as a table top, container or container lid, as shown in FIG. 7, to cause the quantity of bait 22 to become substantially encased and compressed about fishhook 26. To eject the quantity of bait 22, now encasing fishhook 26, the user pushes against disk member 42 to cause first end 34 of plunger member 14 to push quantity of bait 22 and fishhook 26 out of bait chamber 20, as shown in FIG. 8, so that the bait may be cast to catch a fish. Because the quantity of bait 22 is tightly compressed around fishhook 26, it will avoid falling off during casting, being easily removed by fish nibbles and may be recast as necessary.

In the preferred embodiment, fishhook baiting apparatus 10 of the present invention is adaptable for different sizes and types of fishhooks, including the three prong type shown in FIG. 5. As set forth above, some of the prior art devices are limited to standard, single prong hooks by the use of one or more slots or other mechanisms that limit their usefulness for most fishermen and women. If desired, fishhook baiting apparatus 10 can be supplied in different sizes to accommodate different sizes of fishhooks 26 and different bait loading requirements. For instance, tubular member 12 can be two to four inches long with a one-half to three-fourths of an inch outside diameter and a three-eighths to five-eighths inside diameter having lateral extensions approximately one-half inch in length. Plunger member 14 can be two and one-half inches to four and one-half inches long having circular member 40 slightly smaller than the inside diameter of tubular member 12 and a disk member 42 one-eighth of an inch or more larger than the outside diameter of tubular member 12. Although fishhook baiting apparatus 10 is shown and described with cylindrically shaped tubular member 12 and plunger member 14 and round circular member 40 and disk member 42, those skilled in the art will recognize that the apparatus 10 can be manufactured with components of different configurations, such as square, rectangular, triangular, hexagon or various other shapes, along as these components are in suitable cooperating relationship with each other.

Not having to contact the bait 22 or 24 during the process of loading the quantity of bait 22 on fishhook 26 prevents the fisherman or woman from getting bait smell on their body, clothes and equipment and reduces the likelihood of human smells contaminating the quantity of bait 22 used to attract fish to fishhook 26. In addition to virtually eliminating the inconvenience and other problems associated with having to directly contact the bait 22 or 24, the fishhook baiting apparatus 10 of the present invention also provides improved compression of the quantity of bait 22 on fishhook 26 to permit multiple casts of the same bait loading. Fishhook baiting apparatus 10 also reduces the likelihood of accidently hooking the hand or finger with fishhook 26 during the process of placing bait 22 on fishhook 26. Because of its reduced size and lack of components that are likely to become clogged, jammed or damaged by bait 22 and/or the fishing environment, the fishhook baiting apparatus 10 is convenient to carry and reliable to use.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

What is claimed is:

1. A fishhook baiting apparatus for substantially encasing a fishhook with a quantity of bait from a supply of bait, said apparatus comprising:
a generally elongated tubular member having a first end, a second end and a bait chamber disposed therebetween, said first end of said tubular member configured to be inserted into said supply of bait and receive said quantity of bait in said bait chamber; and
an elongated plunger member slidably disposed in said bait chamber, said plunger member having a first end configured to engage said quantity of bait in said bait chamber and a second end configured to prevent complete entry of said plunger member into said bait chamber.

2. The apparatus according to claim 1, wherein said tubular member is made out of a transparent material.

3. The apparatus according to claim 1, wherein said plunger member has a plunger body configured to slidably engage the interior of said bait chamber.

4. The apparatus according to claim 1, wherein said second end of said tubular member and said first end of said plunger member are cooperatively configured to prevent said first end of said plunger member from being easily removed from said second end of said tubular member.

5. The apparatus according to claim 1, wherein said first end of said tubular member and said first end of said plunger member are cooperatively configured to prevent said first end of said plunger member from being extending substantially beyond said end of said tubular member.

6. The apparatus according to claim 5, wherein said second end of said tubular member and said first end of said plunger member are cooperatively configured to prevent said first end of said plunger member from being easily removed from said second end of said tubular member.

7. The apparatus according to claim 1, wherein said second end of said plunger member comprises a disk member sized and configured to prevent entry of said disk member into said bait chamber.

8. The apparatus according to claim 1, wherein said first end of said tubular member is sized and configured to substantially completely receive said fishhook inside said bait chamber.

9. The apparatus according to claim 1, wherein said second end of said tubular member has one or more lateral extensions configured to permit grasping of said tubular member.

10. The apparatus according to claim 1, wherein said lateral extensions are generally perpendicular to the longitudinal axis of said tubular member.

11. A fishhook baiting apparatus for substantially encasing a fishhook with a quantity of bait from a supply of bait, said apparatus comprising:
a generally elongated tubular member having a first end, a second end and a bait chamber disposed therebetween, said first end of said tubular member configured to be inserted into said supply of bait and receive said quantity of bait in said bait chamber, said second end of said tubular member configured with one or more lateral extensions configured to permit grasping of said tubular member; and
an elongated plunger member slidably disposed in said bait chamber, said plunger member having a first end configured to engage said quantity of bait in said bait chamber, a second end configured to prevent complete entry of said plunger member into said bait chamber and a plunger body disposed generally therebetween and configured to slidably engage the interior of said bait chamber, said second end of said tubular member and said first end of said plunger member cooperatively configured to prevent said first end of said plunger member from being easily removed from said second end of said tubular member;
whereby said fishhook is inserted into said quantity of bait in said bait chamber and said plunger member is configured to expel said quantity of bait from said bait chamber and encase said fishhook with said quantity of bait.

12. The apparatus according to claim 11, wherein said tubular member is made out of a transparent material.

13. The apparatus according to claim 1, wherein said second end of said plunger member comprises a disk member sized and configured to prevent entry of said disk member into said bait chamber.

14. The apparatus according to claim 11, wherein said first end of said tubular member is sized and configured to substantially completely receive said fishhook inside said bait chamber.

15. The apparatus according to claim 11, wherein said lateral extensions are generally perpendicular to the longitudinal axis of said tubular member.

16. A fishhook baiting apparatus for substantially encasing a fishhook with a quantity of bait from a supply of bait, said apparatus comprising:
a generally elongated tubular member having a first end, a second end and a bait chamber disposed therebetween, said first end of said tubular member configured to be inserted into said supply of bait and receive said quantity of bait in said bait chamber, said second end of said tubular member configured with one or more lateral extensions configured to permit grasping of said tubular member, said tubular member sized and configured to substantially completely receive said fishhook inside said bait chamber, said tubular member made out of a transparent material; and
an elongated plunger member slidably disposed in said bait chamber, said plunger member having a first end configured to engage said quantity of bait in said bait chamber, a second end configured to prevent complete entry of said plunger member into said bait chamber and a plunger body disposed generally therebetween and configured to slidably engage the interior of said bait chamber, said second end of said tubular member and said first end of said plunger member cooperatively configured to prevent said first end of said plunger member from being easily removed from said second end of said tubular member.

17. The apparatus according to claim 16, wherein said first end of said tubular member and said first end of said plunger member are cooperatively configured to prevent said first end of said plunger member from being extending substantially beyond said end of said tubular member.

18. The apparatus according to claim 16, wherein said second end of said tubular member has one or more lateral extensions configured to permit grasping of said tubular member.
